(19) United States
(12) Patent Application Publication
(10) Pub. No.: US 2013/0260743 A1
(43) Pub. Date: Oct. 3, 2013

(54) METHOD AND DEVICE FOR IDENTIFYING VERY ANNOYING PEOPLE IN MOBILE COMMUNICATION NETWORK

(71) Applicant: Huawei Technologies Co., Ltd., Shenzhen (CN)

(72) Inventors: Xiufeng Wang, Xi'an (CN); Zhenglei Xu, Shanghai (CN); Liang Deng, Xi'an (CN); Xin Chen, Shenzhen (CN)

(21) Appl. No.: 13/907,118

(22) Filed: May 31, 2013

Related U.S. Application Data
(63) Continuation of application No. PCT/CN2012/078275, filed on Jul. 6, 2012.

(30) Foreign Application Priority Data
Nov. 25, 2011 (CN) 201110382249.X

(51) Int. Cl. H04W 24/08

(52) U.S. Cl. CPC H04W 24/08
USPC 455/422.1

(57) ABSTRACT

The present disclosure provides a method and a device for identifying very annoying people in a mobile communication network, in which a server receives and parses a call history record CHR log sent by a network management system, then determines whether a call of a subscriber is an abnormal call according to a parsing result, counts the abnormal call of the subscriber according to the CHR log, and finally identifies a very annoying VAP subscriber according to a counting result of abnormal calls. With the solutions provided by the present disclosure, the VAP subscriber in the mobile communication network can be identified with high accuracy.

### CROSS-REFERENCE TO RELATED APPLICATIONS

This application is a continuation of International Application No. PCT/CN2012/078275, filed on Jul. 6, 2012, which claims priority to Chinese Patent Application No. 201110382249.X, filed on Nov. 25, 2011, both of which are hereby incorporated by reference in their entireties.

### FIELD

The present disclosure relates to the field of wireless communication technologies, and in particular, to a method and a device for identifying very annoying people in a mobile communication network.

### BACKGROUND

The perception of a subscriber is an intuitive feeling of quality of service after the subscriber uses a communication service. The subjective perception of the subscriber is important for a telecom operator. If the subscriber has a good feeling for a certain communication service, the subscriber is promoted to use the service. In a statistical period, if the subjective perception of a subscriber is poor, and the subscriber cannot receive care from the operator, the subscriber may complain and even change carriers. Therefore, it is very necessary for a telecom operator to accurately identify potential subscribers who have poor subjective perception and may complain or change carriers, and offer preventive care to the subscribers, or offer active care to subscribers with important values.

### SUMMARY

The present disclosure provides a method and a device for identifying a subscriber in a mobile communication network, which can identify the very annoying people in the mobile communication network with high accuracy, where the method includes: receiving and parsing, by a server, a CHR (Call History Record) log sent by a network management system; determining whether a call of a subscriber is an abnormal call according to a parsing result; counting the abnormal call of the subscriber according to the CHR log; and identifying a very annoying VAP (Very Annoying People) subscriber according to a counting result of abnormal calls.

The present disclosure further provides a network device in a mobile communication network, including: a receiving unit, configured to receive a call history record CHR log sent by a network management system; a parsing unit, configured to parse the CHR log; a determining unit, configured to determine whether a call of a subscriber is an abnormal call according to a parsing result; a counting unit, configured to count the abnormal call of the subscriber according to the CHR log; and an identifying unit, configured to identify a very annoying VAP subscriber according to a counting result of abnormal calls.

In the method and the device for identifying very annoying people in a mobile communication network provided by the present disclosure, first, a server receives and parses a call history record CHR log sent by a network management system, then determines whether a call of a subscriber is an abnormal call according to a parsing result, counts the abnormal call of the subscriber in a period according to the CHR log, and finally, identifies the very annoying VAP subscriber according to the counting result of abnormal calls. The solutions provided by the present disclosure can identify the VAP subscriber in a mobile communication network with high accuracy.

### BRIEF DESCRIPTION OF THE DRAWINGS

FIG. 1 is an example flow chart of a method for identifying very annoying people in a mobile communication network provided by an embodiment of the present disclosure;

FIG. 2 is an example diagram of key indicators in CHR logs that are concerned by coverage, access, sustainability and voice quality dimensions provided by an embodiment of the present disclosure;

FIG. 3 is an example diagram of an identification rule of a method for identifying a VAP subscriber provided by an embodiment of the present disclosure; and

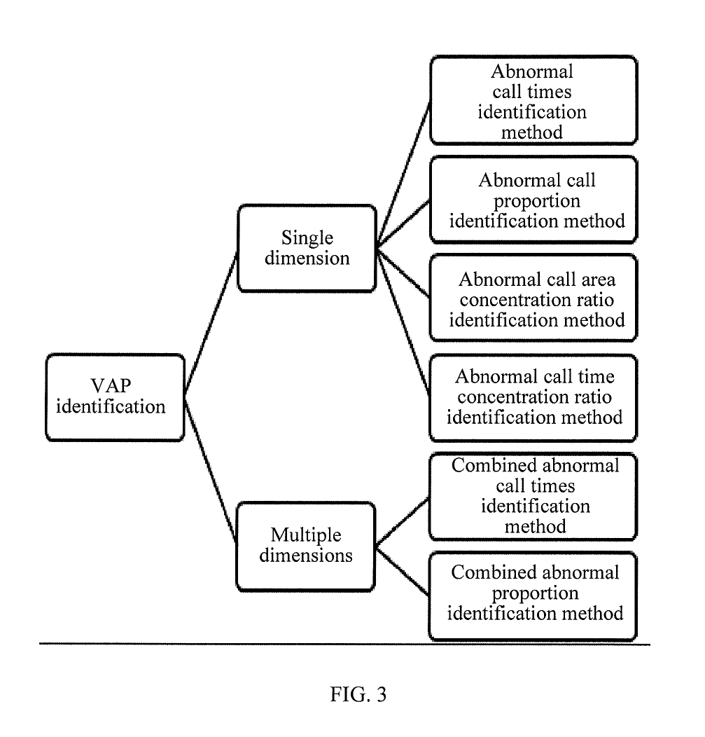

FIG. 4 is an example schematic structural diagram of a device for identifying very annoying people in a mobile communication network provided by an embodiment of the present disclosure.

### DETAILED DESCRIPTION OF THE EMBODIMENTS

To make persons skilled in the art better understand the solutions of the present disclosure, the following clearly and completely describes the solutions according to the embodiments of the present disclosure with reference to the accompanying drawings in the embodiments of the present disclosure. Apparently, the described embodiments are merely a part rather than all of the embodiments of the present disclosure. All other embodiments obtained by persons of ordinary skill in the art based on the embodiments of the present disclosure without creative efforts shall fall within the protection scope of the present disclosure.

The various technologies described herein may be used in various wireless communication systems such as the current 2G and 3G communication systems and the next-generation communication system. For example, the present disclosure is applicable to wireless networks such as UMTS (Universal Mobile Telecommunications System), GSM (Global System for Mobile communications), GPRS (General Packet Radio Service), CDMA2000 (Code Division Multiple Access 2000), TD-SCDMA (Time Division-Synchronous Code Division Multiple Access), LTE (Long Term Evolution), WLAN (Wireless Local Area Network)/WiFi (Wireless Fidelity) and WiMAX (Worldwide Interoperability for Microwave Access).

Further, the terms “system” and “network” can always be used interchangeably in this document. The term “and/or” in this document is only to describe an association relationship of associated objects, and represents that three relationships may exist, for example, A and/or B may represent the following three cases: A exists separately, both A and B exist, and B exists separately.

At present, the method for identifying very annoying people in a mobile communication network is mainly to evaluate perception of a subscriber group or subscribers in a certain area by surveying current network subscribers or testing a specific terminal.

However, a method for surveying the current network subscribers needs to consume a large amount of resources of a telecom operator, and an operation and maintenance cost is high and the volume of analyzable data is small. Moreover, in a method for testing a specific terminal, the volume of analyzable data is also small, and the situation of taking a part for the whole may occur.

In view of the above defects, an embodiment of the present disclosure provides a method for identifying very annoying people in a mobile communication network, where the method mainly includes:

receiving and parsing, by a server, a call history record CHR log sent by a network management system;

determining whether a call of a subscriber is an abnormal call according to a parsing result;

counting the abnormal call of the subscriber according to the CHR log; and

identifying a very annoying VAP subscriber according to a counting result of abnormal calls.

The present disclosure is further described in the following with reference to the accompanying drawing and specific embodiments.

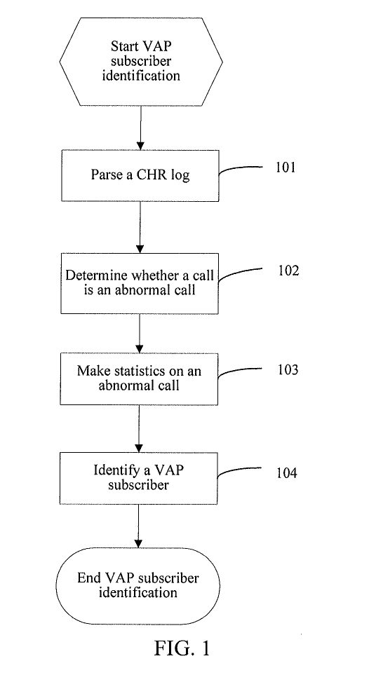

As shown in FIG. 1, a method for identifying very annoying people in a mobile communication network provided by this embodiment includes:

Step 101: A server receives and parses a call history record CHR log sent by a network management system.

Based on call signaling, the network management system records CHR logs of all calls, and a CHR log is used to record history information of a call and analyze abnormal signaling of a call and a reason, for example, the timestamp of a key signaling point, a release type and a reason, handover information (a handover reason and resources occupied before and after handover, and so on), and measurement information. In this step, the network management system sends a recorded CHR log to the server, and the server parses the recorded CHR log.

In this embodiment, a CHR log of a period is selected and parsed, and the period may be set by a telecom operator according to factors such as characteristics of a subscriber and analysis objectives. If the period set to be too short, the number of calls in the period is small and the volume of analysis samples is insufficient; and if the period set to be too long, lack of timeliness is caused. In this embodiment, the period may be set to be one week, which is an empirical value obtained on the basis of actual situations according to this embodiment.

In this embodiment, the CHR logs of subscribers in all base station controllers BSCs or a part of the BSCs in a whole network are parsed. A BSC (base station controller) is a connection point between a base station transceiver station and a mobile switching center, and is a network unit mainly responsible for management of wireless network resources, cell material management, power control, positioning and handover. The mobile communication network is deployed with multiple BSCs, each BSC manages mobile communication of multiple subscribers, the range may be set by a telecom operator according to factors such as analysis objectives, and according to actual situations, the operator may select the CHR logs of the subscribers in all the BSCs in the whole network, or merely select the CHR logs of the subscribers in a part of the BSCs. In this embodiment, the CHR logs of the subscribers in all the BSCs in the whole network are selected to identify VAP subscribers in the whole network.

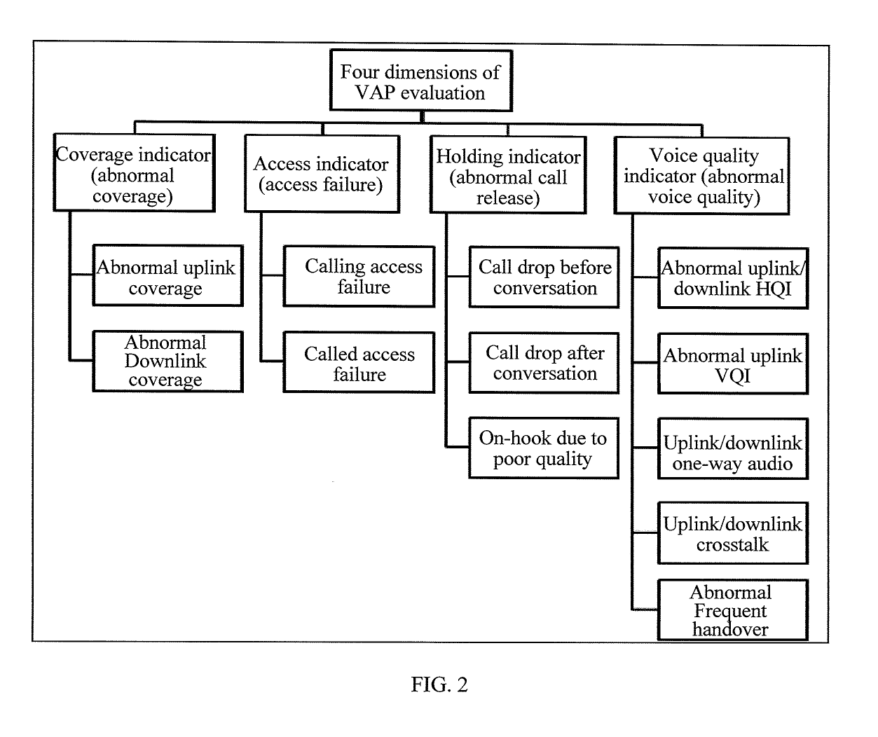

The server extracts key indicators of CHR logs in a period from coverage, access, sustainability and voice quality dimensions for analysis, and the key indicators that are concerned by each of the four dimensions are shown in FIG. 2.

The key indicators in the coverage dimension include uplink coverage abnormality and downlink coverage abnormality.

The uplink coverage abnormality refers to that the access level of a call is less than a set uplink level threshold or the average uplink receiving level of the call is less than the set uplink level threshold.

The downlink coverage abnormality refers to that the average downlink receiving level of the call is less than a set downlink level threshold.

In the coverage dimension of this embodiment, the uplink level threshold may be set to be −100 dBm, and the downlink level threshold may be set to be −90 dBm, both of which are empirical values obtained on the basis of actual situations according to the embodiment of the present disclosure.

The key indicators in the access dimension include calling access failure and called access failure.

The calling access failure refers to that a calling call fails to receive an ALERTING message, and is the access failure caused by a non-subscriber behavior or due to a peer end.

The called access failure refers to that a called call fails to receive an ALERTING message, and is the access failure caused by a non-subscriber behavior or due to a peer end.

The key indicators in the sustainability dimension include call drop before a conversation, call drop after a conversation and on-hook due to poor quality.

The call drop before a conversation refers to that a call establishment result is “disconnect before connect acknowledge”, and the call establishment failure is caused by an abnormal non-subscriber behavior.

The call drop after a conversation refers to that call establishment is successful, and a call finishing result is that a DISCONNECT message is received, and the failure is caused by a non-subscriber behavior or due to a peer end.

The on-hook due to poor quality refers to that the call ends normally on a signaling plane, but no measurement report exists in N seconds before the release of a channel or uplink/downlink average quality in the last M seconds is greater than a set receiving quality threshold. In this type of call, generally, a subscriber cannot endure poor voice quality and goes on-hook actively.

In the sustainability dimension of this embodiment, N may be set to be 7 seconds, M may be set to be 10 seconds; the receiving quality threshold varies with different terminal standards. If a terminal standard in this embodiment is GSM, the receiving quality threshold may be set to be 6 or 7, where the values are empirical values obtained on the basis of actual situations according to the embodiment of the present disclosure.

The key indicator in the voice quality dimension includes an uplink/downlink HQI (High Quality Index) abnormality, an uplink VQI (Voice Quality Indicator) abnormality, uplink/downlink one-way audio, uplink/downlink crosstalk and frequent handover abnormality.

The uplink/downlink HQI abnormality refers to that the MR proportion of high uplink/downlink receiving quality of the call is less than a set threshold for high-receiving quality proportion.

The uplink VQI abnormality refers to that the uplink average VQI of the call is lower than a set low VQI threshold, or a ratio of the time when an uplink VQI is excessively low to a total duration of the call is greater than a set threshold for low VQI duration proportion.

The uplink/downlink one-way audio refers to that the call has a one-way audio call record in a CHR.

The uplink/downlink crosstalk refers to that the call has a crosstalk call record in a CHR.

The frequent handover abnormality refers to that in one conversation of the call, when the number of times of handover is high and exceeds a set threshold for frequent handover times, and the average handover interval is short and less than a set threshold for frequent handover minimum interval, the call is considered to be a frequent handover call.

In the voice quality dimension of this embodiment, the HQI and the VQI are both based on a measurement report MR (Measurement Report, measurement report) reported by a base station. Receiving quality refers to conversation quality evaluated by calculating the BER (Bit Error Rate, bit error rate) during a wireless transmission process. The measurement of the receiving quality is based on the BER, so a clear approximately linear relationship exists between the receiving quality and the BER, and the specific correspondence is shown in Table 1 below:

TABLE 1

| Receiving quality | BER range |
|---|---|
| 0 | BER < 0.2% |
| 1 | 0.2 <= BER < 0.4% |
| 2 | 0.4 <= BER < 0.8% |
| 3 | 0.8 <= BER < 1.6% |
| 4 | 1.6 <= BER < 3.2% |
| 5 | 3.2 <= BER < 6.4% |
| 6 | 6.4 <= BER < 12.84% |
| 7 | BER >= 12.8% |

The BER is a probability that a bit is wrongly transmitted in a data transmission process, and is an average statistical value in a relatively long period of time. The HQI refers to the proportion of high quality receiving in one call, and may be the ratio of the number of MRs with the receiving quality of 0-5 to the number of MRs with the receiving quality of 0-7 in one call in this embodiment. The VQI is a method for evaluating voice quality by using a parameter. In the VQI, subscriber air-interface quality information is automatically collected through a network, and the conversation voice quality of a call of a subscriber in the current conversation is fitted and evaluated through an algorithm. The VQI describes the correspondence between wireless transmission performance and voice quality. By using a VQI technology, a relationship between wireless performance and voice quality is established by grading the voice quality, so that the influence of the wireless performance on voice can be intuitively measured and determined in a network optimization process. The grading standard of the VQI on the voice quality is 0-5, and the higher a grade is, the better the voice quality is.

A standard may be set for the high uplink/downlink receiving quality. In this embodiment, a call with the uplink/downlink receiving quality of 0-5 may be set as a call with high uplink/downlink receiving quality, and the ratio of the number of times of calls with the uplink/downlink receiving quality of 0-5 to the number of times of calls with the uplink/downlink receiving quality of 0-7 is set to be the proportion of the high uplink/downlink receiving quality; a high receiving quality proportion threshold may be set to be 0.7; a low VQI threshold varies with different terminal standards. If a terminal standard is GSM, in this embodiment, the low VQI threshold may be set to be 2.7, a low VQI duration proportion threshold may be set to be 0.1, a frequent handover times threshold may be set to be 4; a frequent handover minimum interval threshold may be set to be 10 s; and all the values are empirical values obtained on the basis of actual situations according to the embodiment of the present disclosure.

Step 202: Determine whether a call of a subscriber is an abnormal call according to a parsing result.

According to the key indicators in the above four dimensions, the CHR logs of the subscribers in the whole network in a certain period are analyzed, and a call meeting any one of the key indicators in the above four dimensions is determined as an abnormal call. For example, if a call drops before a call conversation, the call is an abnormal call; and if the frequent handover of a call is abnormal, and on-hook due to poor quality occurs, the call is an abnormal call.

Step 203: Count the abnormal call of the subscriber according to the CHR log.

From a single dimension and multiple dimensions, the counting regarding the abnormal call of the subscriber may include single dimension counting and multiple dimension combined counting.

The single dimension refers to any one of coverage, access, sustainability and voice quality dimensions, and multiple dimensions refer to any dimensions of the coverage, access, sustainability and voice quality dimensions.

The single dimension counting refers to counting the abnormal call of the subscriber from any one of coverage, access, sustainability and voice quality dimensions, regarding four values, namely, abnormal call times, abnormal call proportion, abnormal call area concentration ratio and abnormal call time concentration ratio. The specific meaning of the four statistical values is:

1) Abnormal Call Times

In the single dimension, the abnormal call times refers to the absolute times of the abnormal call of a subscriber. For example, if a call drops before a call conversation of a subscriber, the call is marked as an abnormal call, and the number of abnormal call times of the subscriber in the sustainability dimension is added by 1; and if the frequent handover of a call of the subscriber is abnormal, and on-hook due to poor quality occurs, the call is marked as an abnormal call, and the number of abnormal call times of the subscriber in each of the sustainability dimension and the voice quality dimension is added by 1.

2) Abnormal Call Proportion

In the single dimension, the abnormal call proportion refers to the number of abnormal call times of a subscriber/the total number of call times of the subscriber. For example, if the total number of call times of a subscriber in a period is 100, where the number of times of calling access failure is 5, the number of times of on-hook due to poor quality is 10, the proportion of abnormal calls of the subscriber in the access dimension is 5%, and the proportion of abnormal calls in the sustainability dimension is 10%.

3) Abnormal Call Area Concentration Ratio

In the single dimension, the abnormal call area concentration ratio refers to the total number of abnormal call times in a TOPN cell in an area where the abnormal call of a subscriber is concentrated. N may be set to be 1 or 2, where the values are empirical values obtained on the basis of actual situations according to this embodiment.

4) Abnormal Call Time Concentration Ratio

In the single dimension, in a period, the abnormal call time concentration ratio refers to the number of abnormal call times in a period of time in which the abnormal call of a subscriber is the most concentrated. The period of time in which the abnormal call is the most concentrated may be 1 to 2 days in which the abnormal call occurs most seriously in the period, where the values are empirical values obtained on the basis of actual situations according to this embodiment.

The multiple-dimension combined counting refers to counting the abnormal call of the subscriber from any dimensions of the coverage, access, sustainability and voice quality dimensions, regarding two values, namely, combined abnormal call times and combined abnormal call proportion. The specific meaning of the two statistical values is:

1) Combined Abnormal Call Times

The combined abnormal call times refers to the combined abnormal call times of the subscriber, and the calculation formula is:

combined abnormal call times=Σsingle-dimension abnormal call times*single-dimension weight

2) Combined Abnormal Call Proportion

The combined abnormal call proportion refers to the combined abnormal call proportion of the subscriber, and the calculation formula is:

combined abnormal call proportion=Σsingle-dimension abnormal call proportion*single-dimension weight

The significance of the multiple-dimension combined counting is that, when the abnormal call of the subscriber in each dimension does not reach a threshold of a VAP subscriber, but the abnormal call times in the dimensions are approximately the same, the subscriber also has poor perception. The single-dimension weight in the calculation formula is set according to factors such as the influence of each dimension on a subscriber's perception, previous subscriber survey data and characteristics of local complaining subscribers in actual situations.

Step 204: Identify a very annoying VAP subscriber according to the counting result of abnormal calls.

According to the counting method of the abnormal calls of subscribers in the whole network in step 203, the method for identifying a VAP subscriber also includes single-dimension identification and multiple-dimension combined identification for the subscriber from the single dimension and the multiple dimensions.

The single-dimension identification refers to identify a VAP subscriber from any one of coverage, access, sustainability and voice quality dimensions, where four identification methods are involved: an abnormal call times identification method, an abnormal call proportion identification method, an abnormal call area concentration ratio identification method and an abnormal call time concentration ratio identification method. The identification rules of the four identification methods include:

1) Abnormal Call Times Identification Method

If XX_ABNORMAL_TIME>XX_VAP_THRESHOLD, the subscriber is a VAP subscriber:

XX represents any one of the coverage, access, sustainability and voice quality dimensions;

XX_ABNORMAL_TIME is the abnormal call times of the subscriber; and

XX_VAP_THRESHOLD is an abnormal times threshold of the VAP subscriber of the corresponding dimension.

2) Abnormal Call Proportion Identification Method

The subscriber satisfying the following two conditions a) and b) at the same time is a VAP subscriber:

a) XX_CALL_TIME>CALL_TIME_THRESHOLD; and

b) XX_ABNORMAL_TIME/XX_CALL_TIME>=XX_RATE_VAP_THRESHOLD.

XX represents any one of the coverage, access, sustainability and voice quality dimensions;

XX_CALL_TIME is the total number of call times of the subscriber;

CALL_TIME_THRESHOLD is an active conversation threshold of the subscriber;

XX_ABNORMAL_TIME is the abnormal call times of the subscriber; and

XX_RATE_VAP_THRESHOLD is the abnormal proportion threshold of the VAP subscriber of the corresponding dimension.

The objective of the condition a) is to filter out a subscriber that has a few conversations in a counting period and has no counting significance.

3) The abnormal call area concentration ratio identification method

XX_ABNORMAL_TIME_TOPN_CELL>=XX_TOPN_CELL_THRESHOLD (N=1, 2 . . . )

XX represents any one of the coverage, access, sustainability and voice quality dimensions;

XX_ABNORMAL_TIME_TOPN_CELL is the total number of abnormal times of the subscriber in a TOPN cell; and

XX_TOPN_CELL_THRESHOLD is the area concentration ratio threshold of the VAP subscriber of the corresponding dimension.

The significance of the abnormal call area concentration ratio identification method is that: the activity area of a single subscriber is generally concentrated in one or several areas. If the number of abnormal times is large in the area where the subscriber usually performs activity, the probability of filing a complaint is great; while in other temporary activity areas, even if the subscriber's perception is poor, the probability of filing a complaint by the subscriber is low. For the convenience of processing, activity areas are mapped to cells, whether N cells where the abnormality of a call for the single subscriber is the most serious reach a set threshold for area concentration ratio is determined.

4) Abnormal call time concentration ratio identification method

XX_ABNORMAL_TIME_TOPN_DAY>=XX_TOPN_DAY_THRESHOLD (N=1, 2 . . . ).

XX represents any one of the coverage, access, sustainability and voice quality dimensions;

XX_ABNORMAL_TIME_TOPN_DAY is the total number of abnormal times in a time range where the abnormality for the subscriber is the most serious; and

XX_TOPN_DAY_THRESHOLD is the time concentration ratio threshold of the VAP subscriber of the corresponding dimension.

The significance of the abnormal call time concentration ratio identification method is that: if the abnormal call of the single subscriber is very serious in a short period, for example, if the number of abnormal call times in one day is very high, the subscriber's perception may be decreased sharply, and even a complaint is filed.

The multiple dimensions identification refers to identify a VAP subscriber from any dimensions of the coverage, access, sustainability and voice quality dimensions, where two identification methods are involved: a combined abnormal call times identification method and a combined abnormal call proportion identification method. The identification rules of the two identification methods are:

1) Combined abnormal call times identification method

If Comb_ABNORMAL_TIME>Comb_VAP_THRESHOLD, the subscriber is a VAP subscriber.

Comb_ABNORMAL_is the combined abnormal call times of the subscriber; and

Comb_VAP_THRESHOLD is the combined abnormal call times threshold of the VAP subscriber.

2) Combined Abnormal Proportion Identification Method

The subscriber satisfying the following two conditions a) and b) at the same time is a VAP subscriber:
a) Comb_CALL_TIME>CALL_TIME_THRESHOLD; and
b) Comb_ABNORMAL_RATE>=CombRATE_VAP_THRESHOLD Comb_CALL_TIME is the total number of call times of the subscriber;
CALL_TIME_THRESHOLD is the active conversation threshold of the subscriber;
Comb_ABNORMAL_RATE is the combined abnormal proportion of the subscriber in the whole network; and
Comb_RATE_VAP_THRESHOLD is the combined abnormal proportion threshold of the VAP subscriber.

The objective of the condition a) is to filter out a subscriber that has a few conversations in a counting period and has no counting significance.

In the six identification methods in the above two categories, the VAP subscriber threshold involved is mainly determined according to factors such as the VAP subscriber proportion determined by an operator, the regional environment where subscribers are and the characteristics of the local complaining subscribers, and different thresholds need to be set according to actual situations.

With the solutions provided by the embodiment of the present disclosure, a potential complaining subscriber with poor perception or intending to change carriers can be identified with high accuracy in the mobile communication network, thereby solving the problem that network operation and maintenance efficiency is low, manpower input is large and the survey cost of a current network subscriber is high in the prior art. While, with the solutions provided by the embodiment of the present disclosure, a VAP subscriber can be identified according to the CHR log of the subscriber, so that the specific perception of a single subscriber is intuitively reflected, and in combination with a judgment criterion that is set according to the characteristics of a complaining subscriber, the accuracy of identifying a potential complaining subscriber is high, thereby providing a foundation for a telecom operator to offer prevention concern on a complaining subscriber and a subscriber intending to change carriers.

### Another Embodiment

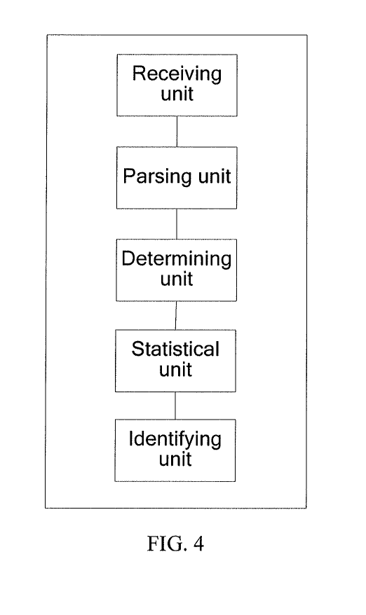

As shown in FIG. 4, on the basis of the foregoing method embodiment, an embodiment of the present disclosure further provides a device for identifying very annoying people in a mobile communication network, including:

a receiving unit, configured to receive a call history record CHR log sent by a network management system;

a parsing unit, configured to parse the CHR log;

a determining unit, configured to determine whether a call of a subscriber is an abnormal call according to a parsing result;

a counting unit, configured to count the abnormal call of the subscriber according to the CHR log; and

an identifying unit, configured to identify a very annoying VAP subscriber according to a counting result of abnormal calls.

It can be clearly understood by persons skilled in the art that, for the purpose of convenient and brief description, for the detailed working process of the foregoing apparatus and unit, reference may be made to the corresponding process in the method embodiments, and details are not described herein again.

In the embodiments provided in the present disclosure, it should be understood that the disclosed apparatus and method may be implemented in other manners. For example, the described apparatus embodiment is merely exemplary. For example, the unit division is merely logical function division and can be other division in actual implementation. For example, multiple units or components can be combined or integrated into another system, or some features can be ignored or not performed. In addition, the displayed or discussed mutual couplings or direct couplings or communication connections are implemented through some interfaces. The indirect couplings or communication connections between the apparatuses or units may be implemented in electronic, mechanical or other forms.

The units described as separate parts may or may not be physically separate, and parts displayed as units may or may not be physical units, may be located in one position, or may be distributed on multiple network units. A part or all of the units may be selected according to actual needs to achieve the objectives of the solutions of the embodiments.

In addition, functional units in each embodiment of the present disclosure may be integrated into a processing unit, or each of the units may exist alone physically, or two or more units are integrated into one unit. The integrated unit may be implemented in a form of hardware, or may be implemented in a form of a software functional unit.

When being implemented in the form of a software functional unit and sold or used as a separate product, the integrated unit may be stored in a computer-readable storage medium. Based on this understanding, the solutions of the present disclosure essentially, or the part contributing to the prior art, or all or a part of the solutions may be implemented in a form of a software product. The computer software product is stored in a storage medium and includes several instructions for instructing a computing device having a hardware processor (which may be a personal computer, a server, a network device or the like) to execute all or a part of the method described in each embodiment of the present disclosure. The storage medium includes: any medium that can store program codes, such as a U-disk, a removable hard disk, a read-only memory (ROM, Read-Only Memory), a random access memory (RAM, Random Access Memory), a magnetic disk, or an optical disk.

The above description is merely about exemplary embodiments of the present disclosure, which enable persons skilled in the art to understand or implement the present disclosure. Various modifications of the embodiments are apparent to persons of ordinary skill in the art, and general principles defined in the specification can be implemented in other embodiments without departing from the idea or scope of the present disclosure. Therefore, the present disclosure is not limited to the embodiments described in the document but extends to the widest scope that complies with the principle and novelty disclosed in the document.

What is claimed is:

1. A method for identifying a subscriber in a mobile communication network, comprising:
parsing, by a server, a call history record (CHR) log of a period;
determining, by the server, whether each of calls of a subscriber is an abnormal call according to a parsing result;
counting, by the server, the abnormal call of the subscriber according to the CHR log; and
identifying, by the server, a very annoying people (VAP) subscriber according to a counting result.

2. The method according to claim 1, wherein parsing the CHR log of the period comprises:
parsing, by the server, key indicators in the CHR log of the period from at least one of coverage, access, sustainability and voice quality dimensions.

3. The method according to claim 2, wherein the key indicators comprise at least one of the following:
the key indicators in the coverage dimension which comprise uplink coverage abnormality and downlink coverage abnormality;
the key indicators in the access dimension which comprise calling access failure and called access failure;
the key indicators in the sustainability dimension which comprise call drop before a conversation, call drop after a conversation and on-hook due to poor quality; and
the key indicators in the voice quality dimension which comprise uplink/downlink high quality index (HQI) abnormality, uplink voice quality indicator (VQI) abnormality, uplink/downlink one-way audio, uplink/downlink crosstalk and frequent handover abnormality.

4. The method according to claim 3, wherein determining whether each of calls of the subscriber is the abnormal call according to the parsing result comprises:
if a call of the subscriber meets any one of the key indicators, the call is an abnormal call.

5. The method according to claim 2, wherein counting the abnormal call of the subscriber according to the CHR log comprises:
counting, by the server, the abnormal call of the subscriber from a single dimension or multiple dimensions of the coverage, access, sustainability and voice quality dimensions.

6. The method according to claim 5, wherein counting the abnormal call of the subscriber from the single dimension of the coverage, access, sustainability and voice quality dimensions comprises:
counting, by the server, the abnormal call of the subscriber regarding at least one value of the following four statistical values from any one of the coverage, access, sustainability and voice quality dimensions:
abnormal call times, abnormal call proportion, abnormal call area concentration ratio, and abnormal call time concentration ratio.

7. The method according to claim 5, wherein counting the abnormal call of the subscriber from the multiple dimensions of the coverage, access, sustainability and voice quality dimensions comprises:
counting, by the server, the abnormal call of the subscriber regarding at least one value of the following two statistical values from at least two of the coverage, access, sustainability and voice quality dimensions:
combined abnormal call times and combined abnormal call proportion.

8. The method according to claim 6, wherein identifying the VAP subscriber according to a counting result comprises:
the subscriber is the VAP subscriber if at least one of the follow criteria is satisfied:
the abnormal call times of the subscriber in the single dimension is greater than an abnormal times threshold of the corresponding dimension;
the total number of call times of the subscriber is greater than an active conversation threshold of the subscriber, and the abnormal call proportion in the single dimension of the subscriber is greater than or equal to an abnormal proportion threshold of the corresponding dimension;
the abnormal call area concentration ratio of the subscriber in the single dimension is greater than or equal to an area concentration ratio threshold of the corresponding dimension;
the abnormal call time concentration ratio of the subscriber in the single dimension is greater than or equal to a time concentration ratio threshold of the corresponding dimension.

9. The method according to claim 7, wherein identifying the VAP subscriber according to the counting result comprises:
the subscriber is the VAP subscriber if at least one of the follow criteria is satisfied:
the combined abnormal call times of the subscriber in the multiple dimensions is greater than a combined abnormal call times threshold;
the total number of call times of the subscriber in the multiple dimensions is greater than an active conversation threshold of the corresponding dimensions, and the combined abnormal call proportion of the subscriber in the whole network is greater than or equal to a combined abnormal proportion threshold.

10. A network device in a mobile communication network, comprising:
a parsing unit, configured to parse a call history record (CHR) log of a period;
a determining unit, configured to determine whether each of calls of a subscriber is an abnormal call according to a parsing result;
a counting unit, configured to count the abnormal call of the subscriber according to the CHR log; and
a identifying unit, configured to identify a very annoying people (VAP) subscriber according to a counting result.

11. The device according to claim 10, wherein the parsing unit is configured to parse key indicators in the CHR log of the period from at least one of coverage, access, sustainability and voice quality dimensions.

12. The device according to claim 11, wherein the key indicators comprise at least one of the following:
the key indicators in the coverage dimension which comprise uplink coverage abnormality and downlink coverage abnormality;
the key indicators in the access dimension which comprise calling access failure and called access failure;
the key indicators in the sustainability dimension which comprise call drop before a conversation, call drop after a conversation and on-hook due to poor quality; and
the key indicators in the voice quality dimension which comprise uplink/downlink high quality index (HQI) abnormality, uplink voice quality indicator (VQI) abnormality, uplink/downlink one-way audio, uplink/downlink crosstalk and frequent handover abnormality.

13. The device according to claim 12, wherein the determining unit is configured to determine a call of the subscriber is an abnormal call if the call of the subscriber meets any one of the key indicators.

14. The device according to claim 11, wherein the counting unit is configured to count the abnormal call of the subscriber regarding at least one value of the following four statistical values from a single dimension:
abnormal call times, abnormal call proportion, abnormal call area concentration ratio, and abnormal call time concentration ratio;
the single dimension refers to any one of the coverage, access, sustainability and voice quality dimensions.

15. The device according to claim 11, wherein the counting unit is configured to count the abnormal call of the subscriber regarding at least one value of the following two statistical values from multiple dimensions:
combined abnormal call times and combined abnormal call proportion;
the multiple dimensions refer to at least two of the coverage, access, sustainability and voice quality dimensions.

16. The device according to claim 14, wherein the identifying unit is configured to identify the subscriber is the VAP subscriber if at least one of the follow criteria is satisfied:
the abnormal call times of the subscriber in the single dimension is greater than an abnormal times threshold of the corresponding dimension;
the total number of call times of the subscriber is greater than an active conversation threshold of the subscriber, and the abnormal call proportion in the single dimension of the subscriber is greater than or equal to an abnormal proportion threshold of the corresponding dimension;
the abnormal call area concentration ratio of the subscriber in the single dimension is greater than or equal to an area concentration ratio threshold of the corresponding dimension;
the abnormal call time concentration ratio of the subscriber in the single dimension is greater than or equal to a time concentration ratio threshold of the corresponding dimension.

17. The device according to claim 15, wherein the identifying unit is configured to identify the subscriber is the VAP subscriber if at least one of the follow criteria is satisfied:
the combined abnormal call times of the subscriber in the multiple dimensions is greater than a combined abnormal call times threshold;
the total number of call times of the subscriber in the multiple dimensions is greater than an active conversation threshold of the corresponding dimensions, and the combined abnormal call proportion of the subscriber in the whole network is greater than or equal to a combined abnormal proportion threshold.
